(19) United States
(12) Patent Application Publication
(10) Pub. No.: US 2026/0342118 A1
(43) Pub. Date: Oct. 29, 2026

(54) METHOD AND SYSTEM FOR MANAGING AN ELECTRICAL ENERGY SOURCE IN A HYBRID PROPULSION ARCHITECTURE

(71) Applicant: AIRBUS OPERATIONS SAS, Toulouse (FR)

(72) Inventors: Franck ALBERO, Toulouse (FR); lsrae DRISSI EL BOUZAIDI, Toulouse (FR)

(73) Assignee: AIRBUS OPERATIONS SAS, Toulouse (FR)

(21) Appl. No.: 19/647,515

(22) Filed: Apr. 14, 2026

(30) Foreign Application Priority Data
Apr. 28, 2025 (FR) 2504462

(51) Int. Cl. H02J 7/82; B60L 50/15; B64D 31/18; H02J 7/90

(52) U.S. Cl. CPC H02J 7/825; B60L 50/15; B64D 31/18; H02J 7/933; H02J 7/971; B60L 2200/10; B60L 2260/22

(57) ABSTRACT

A method for managing the energy of an electrical energy source in an aircraft having an electric hybrid propulsion architecture, including at least one heat engine and said source. The method includes, for a given mission: during an initial phase, fully charging the source with a quantity of energy distributed, in a determined manner and for the whole duration of the given mission, between various energy reserves, including a particular reserve for the hybrid functions; authorizing use of the particular reserve to execute at least one of the hybrid functions, during at least one of the pre-takeoff taxiing phase and takeoff phase; and recharging the source during a cruising phase in order for the particular reserve to make it possible to execute at least one of the hybrid functions during at least one of the descent phase, landing phase and post-landing taxiing phase.

### TECHNICAL FIELD

The present invention concerns a method and a system for managing the energy of an electrical energy source, such as a battery, in an aircraft having an electric hybrid propulsion architecture.

### PRIOR ART

The present invention applies to aircraft having an electric hybrid propulsion architecture, comprising at least one heat engine using fuel combustion and an electric energy source which is configured to assist the heat engine electrically. In other words, this is an architecture for supplying mechanical power through hybrid energy, namely coming both from using fuel (in the heat engine) and from the energy source, in which electrical assistance is provided to the heat engine.

The electrical energy source (battery, for example) thus notably makes it possible to provide surplus energy to the heat engine for operations requiring high power (such as startup, takeoff or landing, engine acceleration, climbing/descent in altitude, stopping the engine, etc.) and to avoid oversizing the heat engine for short operational phases or emergency situations.

In the present description, “electrical energy source” is a generic term for designating any type of battery, supercapacitor or other electrical energy storage source, as well as any combination of sources of the same type or of different types (among those mentioned above).

Such an electric hybrid propulsion architecture leads to a reduction in fuel consumption and the carbon footprint.

The aim of the present invention is to optimize the use of the electrical energy source (battery, for example) and to avoid discharging it completely before the end of a mission or in a proportion such that safety needs requiring power to be supplied by said electrical energy source may no longer be ensured.

### SUMMARY OF THE INVENTION

A method for managing the energy of an electrical energy source in an aircraft comprising a system for managing the energy of said electrical energy source in an electric hybrid propulsion architecture comprising at least one heat engine using fuel combustion and said electrical energy source is proposed, the energy management system comprising electronic circuitry, the method being implemented by the energy management system and comprising, for a given mission of the aircraft:
during a phase of parking at the boarding point, commanding a complete charge of the electrical energy source with an amount of energy distributed, in a determined manner and for the whole duration of the given mission, between the following energy reserves:
   a first reserve, which is a design safety margin designed to prevent the electrical energy source from exceeding its defined operational limits;
   a second reserve, which guarantees a continuous power supply to essential systems of the aircraft in the event of said at least one engine flaming out;
   a third reserve, which guarantees in-flight relighting of said at least one engine; and
   a fourth reserve, provided for hybrid functions providing, through power injection, electrical assistance to said at least one engine in normal operation;
authorizing use of the fourth reserve to execute at least one of the hybrid functions, during at least one of the following phases: pre-takeoff taxiing and takeoff; and
commanding a recharge of the electrical energy source during a cruising phase, with a sufficient amount of energy for the fourth reserve to be at least partially replenished and make it possible to execute at least one of the hybrid functions during at least one of the following phases: descent, landing and post-landing taxiing.

Thus, for a given mission of the aircraft, the proposed solution makes it possible to optimize the use of the electrical assistance while guaranteeing the execution of the safety functions until the end of this mission. It should be noted that, at the beginning of the mission, during the phase of parking at the boarding point, the electrical energy source is fully charged, with an amount of energy which is distributed between the various energy reserves, in a determined manner and for the whole duration of the given mission. Thus, compared to a conventional solution for energy management by mission segments (solution consisting in dividing the mission into mission segments each having, within the electrical energy source, a predefined electrical energy budget), the proposed solution proposes a fundamental change, with a more global strategy (energy management globally over the whole of the mission) in order to maximize the efficiency of the electrical assistance. The conventional solution mentioned above was justified by the large number and diversity of functions requiring energy. The proposed solution is adapted to new (electric hybrid propulsion) architectures having a reduced functional field and in which the sizing of the electrical energy source (battery, for example) has been optimized.

According to one particular embodiment, the method comprises, for the given mission and if the pre-takeoff taxiing phase is of a duration which is greater than a predetermined duration: commanding a recharge of the electrical energy source during the pre-takeoff taxiing phase, with a sufficient amount of energy for the fourth reserve to be at least partially replenished and make it possible to execute at least one of the hybrid functions during the takeoff phase.

According to one particular embodiment, the method comprises:
authorizing use of at least one of the second reserve and third reserve to execute at least one of the hybrid functions, during at least one of the pre-takeoff taxiing phase and takeoff phase; and
commanding a recharge of the electrical energy source during a climbing phase, with a sufficient amount of energy for the second reserve and third reserve to be fully replenished before the cruising phase.

According to one particular embodiment, during the climbing phase, the recharge of the electrical energy source is configured to be gradual and such that each of the second reserve and third reserve is always replenished in a proportion which is at least equal to a first determined threshold, which is variable and rises as the altitude of the aircraft increases.

According to one particular embodiment, the method comprises:
authorizing use of at least one of the second reserve and third reserve, to execute at least one of the hybrid functions, during at least one of the descent phase, landing phase and post-landing taxiing phase.

According to one particular embodiment, authorizing use of at least one of the second reserve and third reserve, to execute at least one of the hybrid functions during at least one of the descent phase, landing phase and post-landing taxiing phase, is configured to be gradual and such that each of the second reserve and third reserve still contains energy in a proportion which is at least equal to a second determined threshold, which is variable and falls as the altitude of the aircraft decreases.

According to one particular embodiment, the recharge of the electrical energy source during the cruising phase is limited and takes account of the authorization of use of at least one of the second reserve and third reserve to execute at least one of the hybrid functions during at least one of the descent phase, landing phase and post-landing taxiing phase.

According to one particular embodiment, the recharge of the electrical energy source during the cruising phase is complete, so that, at the end of said complete recharge, the fourth reserve is fully replenished and authorizes the execution of all the hybrid functions which must be executed during the descent phase, landing phase and post-landing taxiing phase.

A computer program product, comprising instructions which cause a processor to execute the method alluded to above according to any one of its embodiments, when said instructions are executed by the processor, is also proposed.

A storage medium, storing such instructions which cause the processor to execute the method alluded to above according to any one of its embodiments, when said instructions are read from the storage medium and executed by the processor, is also proposed.

A system for managing the energy of an electrical energy source in an aircraft comprising an electric hybrid propulsion architecture comprising at least one heat engine using fuel combustion and said electrical energy source is also proposed, the energy management system being on board the aircraft and comprising electronic circuitry configured to implement, for a given mission of the aircraft:
during a phase of parking at the boarding point, commanding a complete charge of the electrical energy source with an amount of energy distributed, in a determined manner and for the whole duration of the given mission, between the following energy reserves:
   a first reserve, which is a design safety margin designed to prevent the electrical energy source from exceeding its defined operational limits;
   a second reserve, which guarantees a continuous power supply to essential systems of the aircraft in the event of said at least one engine flaming out;
   a third reserve, which guarantees in-flight relighting of said at least one engine; and
   a fourth reserve, provided for hybrid functions providing, through power injection, electrical assistance to said at least one engine in normal operation;
authorizing use of the fourth reserve to execute at least one of the hybrid functions, during at least one of the following phases: pre-takeoff taxiing and takeoff; and
commanding a recharge of the electrical energy source during a cruising phase, with a sufficient amount of energy for the fourth reserve to be at least partially replenished and make it possible to execute at least one of the hybrid functions during at least one of the following phases: descent, landing and post-landing taxiing.

More generally, an energy management system, configured to execute the method alluded to above, according to any one of its embodiments, is proposed.

An aircraft comprising an energy management system, as alluded to above, is also proposed.

### BRIEF DESCRIPTION OF THE DRAWINGS

The above-mentioned features of the invention, as well as others, will become more clearly apparent on reading the following description of at least one example of an embodiment, said description being given in relation to the appended drawings, among which:

FIG. 1 is a simplified top view of an aircraft equipped with an energy management system according to the present invention;

FIG. 2 illustrates, in block diagram form, the aircraft of FIG. 1 equipped with the energy management system, in one particular embodiment of the present invention;

FIG. 3 schematically illustrates one example of a hardware architecture of the energy management system of FIG. 1;

FIG. 4 schematically illustrates the distribution of the initial charge of the battery over four energy reserves;

FIG. 5 schematically illustrates an energy management algorithm, executed by the energy management system of FIG. 1, in a first embodiment;

FIG. 6 schematically illustrates the various states of charge of the battery over the course of various phases of a given mission, when the algorithm of FIG. 5 is executed;

FIG. 7 schematically illustrates an energy management algorithm, executed by the energy management system of FIG. 1, in a second embodiment;

FIG. 8 schematically illustrates the various states of charge of the battery over the course of various phases of a given mission, when the algorithm of FIG. 7 is executed; and

FIG. 9 schematically illustrates an energy management algorithm, executed by the energy management system of FIG. 1, in a third embodiment.

### DETAILED DESCRIPTION OF EMBODIMENTS

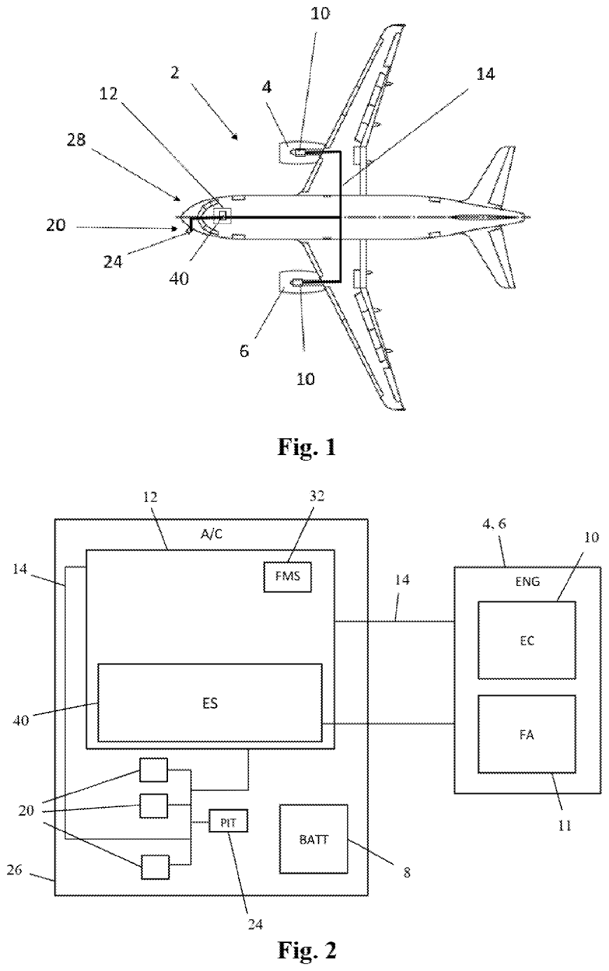

As depicted in FIG. 1, the present invention relates to an aircraft 2 provided with an electric hybrid propulsion architecture, namely, as indicated above, the one or more heat engines of which may be electrically assisted. In such an architecture, the electrical energy may also be used for the needs of the aircraft, such as, for example, those of the equipment of the aircraft and more specifically, for example, the environmental control system (or ECS). The aircraft comprises at least two heat engines 4, 6 (also referenced ENG in FIG. 2) as well as an electrical energy source (for example a battery, referenced BATT 8 in FIG. 2). Each heat engine 4, 6 may be, for example, of turbojet type (for example, a turbofan) or else of ultra-high bypass engine type. Each engine 4, 6 comprises an engine computer 10 (also referenced EC in FIG. 2) and an activation module (referenced 11 and FA in FIG. 2). The activation module 11 (FA) may be integrated into the engine computer 10 (EC) or be independent, as illustrated in FIG. 2. The engine computers 10 of the two engines 4, 6 are connected to an avionics system 12, also called the avionics core, by means of a communication network 14. The communication network 14 also links the avionics system 12 to components 20 of the aircraft which transmit parameters of the aircraft to it. The components 20 are all the elements, equipment and other parts which are necessary for executing functions which are liable to be used by the engines 4, 6, and which make possible assistance by the battery 8 (examples of functions: assistance with engine starting (actuating the starter), assistance with engine acceleration (when the aircraft wishes to accelerate on the ground or in flight), assistance with stopping the engines, idle function, engine cooling, etc.). FIG. 1 depicts one of the components, a pitot probe 24 (also referenced PIT), which makes it possible to measure the parameter of the speed of the aircraft, as an example of a component 20 of the aircraft 2.

As illustrated in FIG. 2, in a schematic and simplified manner, the aircraft 2 comprises, on the one hand, an aircraft portion 26 in its entirety (without the engines 4, 6) and, on the other hand, the engines 4, 6. The aircraft portion 26 (also referenced A/C) makes it possible to control the aircraft so as to carry out its flight and it is connected to the engines 4, 6 (ENG), the latter making it possible to propel the aircraft. All of the systems depicted in the aircraft portion 26 (A/C) may be located in various possible places in the aircraft: this is why they are not depicted in FIG. 1. The avionics system 12, conventionally, is located essentially in the cockpit (referenced 28 in FIG. 1) and/or close to it (as depicted schematically in FIG. 1), but it could be otherwise, at least for a portion of the system.

As already mentioned above, the generic expression “electrical energy source” is used to designate any type of battery, supercapacitor or other energy storage source, as well as any combination of sources of the same type or of different types (among those mentioned above). The source is, in the embodiment illustrated and as indicated above, a battery 8 and, for example, a lithium and, more specifically, lithium-ion battery or, according to another example, an LFP (lithium-iron-phosphate) battery. Throughout the remainder of the description, the charge of the battery 8 will be referred to but, if the electrical energy source is of a type other than a battery, the charge corresponds to the amount of remaining electrical energy which is liable to be delivered by the source.

The aircraft portion 26 (A/C) comprises numerous modules of known type, such as the flight management system 32 (FMS). The avionics system 12 of the cockpit 28 is connected to components 20 by the network 14, as well as to the engines 4, 6 (ENG).

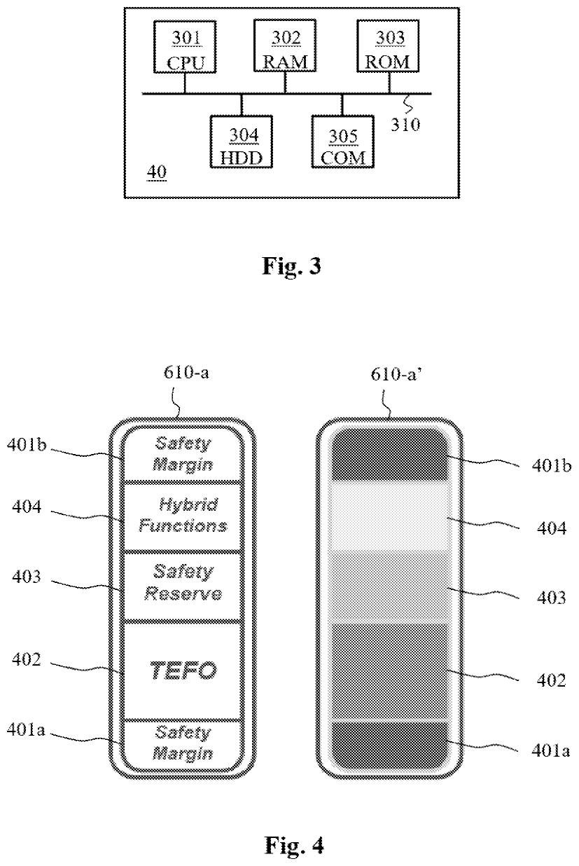

The aircraft 2, and more specifically the avionics system 12 in the embodiment illustrated in FIGS. 1 and 2, includes a system 40 for managing the battery 8 (also called “system for managing the energy of the electrical energy source”). The system 40 for managing the battery 8 is connected to the engines 4, 6 ENG. In one embodiment, it comprises an energy management module EM connected to a control module MC itself connected to the engines 4, 6. The modules EM and MC (not depicted in FIG. 2) may be in the form of a single computer (see FIG. 3) or two computers (these one or more computers being able to be independent or integrated into one or more existing computers). The system 40 for managing the battery 8 is linked to the battery 8 as well as to the communication network 14, making it possible for it to be connected to the aforementioned set of components 20 of the aircraft.

FIG. 3 schematically illustrates one example of a hardware architecture of the system 40 for managing the battery 8, which then comprises, connected by a communication bus 310: a central processing unit or CPU 301; a random-access memory RAM 302; a read-only memory ROM 303, for example a flash memory; a data storage device, such as a hard disk drive HDD, or a storage medium reader, such as an SD (Secure Digital) card reader 304; at least one communication interface 305 making it possible for the system 40 for managing the battery 8 to interact in the avionics of the aircraft.

The processor 301 is capable of executing instructions which form a computer program and which are loaded into the RAM 302 from the ROM 303, from an external memory (not depicted), from another storage medium (such as an SD card), or from a communication network (not depicted). When the system 40 for managing the battery 8 is powered up, the processor 301 is capable of reading the aforementioned instructions from the RAM 302 and of executing them. When they are read (from the RAM 302 or a storage medium) and executed by the processor 301, these instructions (which form a computer program) cause the processor 301 to execute the behaviours, steps and algorithms described here.

All or some of the behaviours, steps and algorithms described here may thus be implemented in software form by executing a set of instructions by means of a programmable machine, such as a DSP (digital signal processor) or a microcontroller, or be implemented in hardware form by a machine or a dedicated chip or a dedicated chipset, such as an FPGA (field-programmable gate array) or ASIC (application-specific integrated circuit). Generally, the system 40 for managing the battery comprises electronic circuitry arranged and configured to implement the behaviours, steps and algorithms described here.

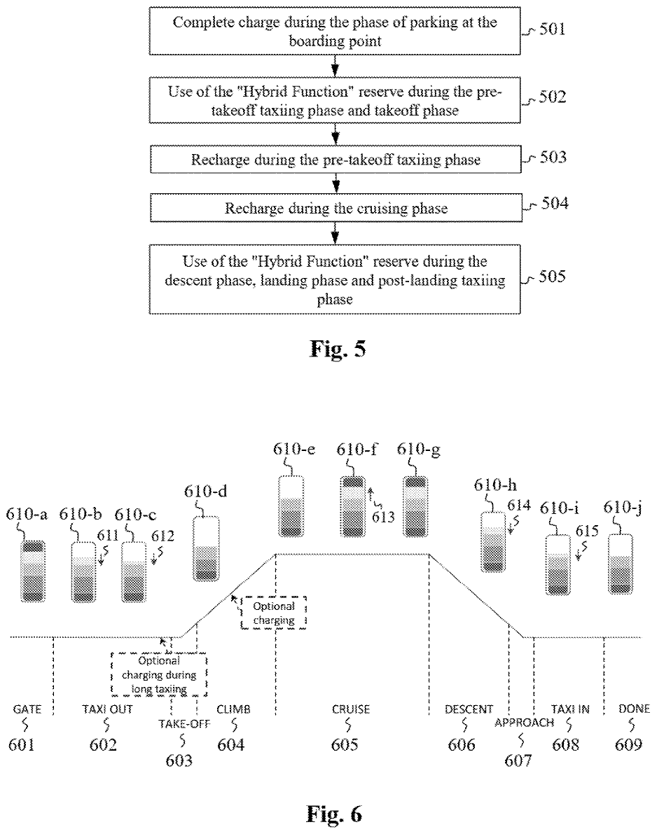

FIG. 5 schematically illustrates an energy management algorithm, executed by the system 40 for managing the battery 8, for a given mission of the aircraft 2, in a first embodiment comprising steps 501 to 505. It is described in conjunction with FIG. 6, which schematically illustrates the various states of charge of the battery 8 over the course of various phases of a given mission, when the algorithm of FIG. 5 is executed.

In the step 501, during a phase of parking at the boarding point (referenced 601 in FIG. 6 and called “Gate”), the system 40 commands a complete charge of the battery 8 with an amount of energy distributed, in a determined manner and for the whole duration of the given mission, between four energy reserves. The state of charge of the battery 8 at the end of this step 501 is referenced 610-a in FIG. 6.

FIG. 4 schematically illustrates this distribution of the initial charge of the battery 8, that is to say of the state of charge 610-a, over the following four energy reserves:
a first reserve, referenced 401a and 401b (and called, for example, “Design Safety Margin Reserve”), which is a design safety margin designed to prevent the battery 8 from exceeding its defined operational limits;
a second reserve, referenced 402 (and called, for example, “TEFO Reserve”), which guarantees a continuous power supply to essential systems of the aircraft in the event of the engines 4, 6 flaming out (or TEFO for “Total Engine Flame Out”);
a third reserve, referenced 403 (and called, for example, “Safety Reserve”), which guarantees in-flight relighting of the engines 4, 6 (or “In-flight engine relight”); and
a fourth reserve, referenced 404 (and called, for example, “Hybrid Function Reserve”), provided for hybrid functions providing, through power injection, electrical assistance to the engines 4, 6 in normal operation.

The right-hand part of FIG. 4 is a greyscale depiction 610-a′ of the aforementioned state of charge 610-a. The four energy reserves 401a/401b, 402, 403 and 404 are therefore found therein.

Returning to FIG. 5, in the step 502, the system 40 authorizes use of the fourth reserve 404 (“Hybrid Function Reserve”) to execute one or more of the hybrid functions, during the pre-takeoff taxiing phase (referenced 602 in FIG. 6 and called “Taxi out”) and/or during the takeoff phase (referenced 603 in FIG. 6 and called “Take-off”). FIG. 6 depicts two successive states, referenced 610-b and 610-c, of the state of charge of the battery 8 over the course of this step 502. The use of the fourth reserve 404, to execute one or more of the hybrid functions, is symbolized therein by the arrows referenced 611 and 612.

In the step 503 (optional), if the pre-takeoff taxiing phase 602 is of a duration which is greater than a predetermined duration, the system 40 commands a recharge of the battery 8 during the pre-takeoff taxiing phase 602, with a sufficient amount of energy for the fourth reserve 404 to be at least partially replenished and make it possible to execute one or more of the hybrid functions during the takeoff phase 603.

During the climbing phase (referenced 604 in FIG. 6 and called “Climb”), the remaining energy (that is to say the second reserve 402 (“TEFO Reserve”), the third reserve 403 (“Safety Reserve”) and the part referenced 401a of the first reserve) is reserved for the safety-critical scenarios, such as the total flameout of the engines 4, 6 (“TEFO”) and the in-flight restart of the engines 4, 6. This remaining energy appears on the state of charge of the battery 8 referenced 610-d in FIG. 6. Charging the battery 8 is optional (possible but not obligatory) during this climbing phase 604.

In the step 504, the system 40 commands a recharge of the battery during a cruising phase (referenced 605 in FIG. 6 and called “Cruise”), with a sufficient amount of energy for the fourth reserve 404 to be at least partially replenished with a view to executing a step 505. FIG. 6 depicts three successive states, referenced 610-e, 610-f and 610-g, of the state of charge of the battery 8 over the course of this step 504. The state 610-e is identical to the state 610-d (this is therefore the case in which the battery 8 has not been recharged during the climbing phase 604). The recharge of the battery appears on the state 610-f, where it is symbolized by the arrow referenced 613. The state 610-g depicts a fully charged battery (as in the initial state 610-a).

In the step 505, the system 40 authorizes use of the fourth reserve 404 to execute one or more of the hybrid functions during the descent phase (referenced 606 in FIG. 6 and called “Descent”) and/or during the landing phase (referenced 607 in FIG. 6 and called “Approach”) and/or during the post-landing taxiing phase (referenced 608 in FIG. 6 and called “Taxi in”). FIG. 6 depicts two successive states, referenced 610-h and 610-i, of the state of charge of the battery 8 over the course of this step 505. The use of the fourth reserve 404, to execute one or more of the hybrid functions, is symbolized therein by the arrows referenced 614 and 615. In the example illustrated in FIG. 6, at the end of the post-landing taxiing phase 608 (and therefore at the beginning of the following phase of parking at the boarding point (referenced 609 in FIG. 6 and called “Done”)), the state of charge of the battery 8 is referenced 610-j and shows that the fourth reserve 404 has been consumed.

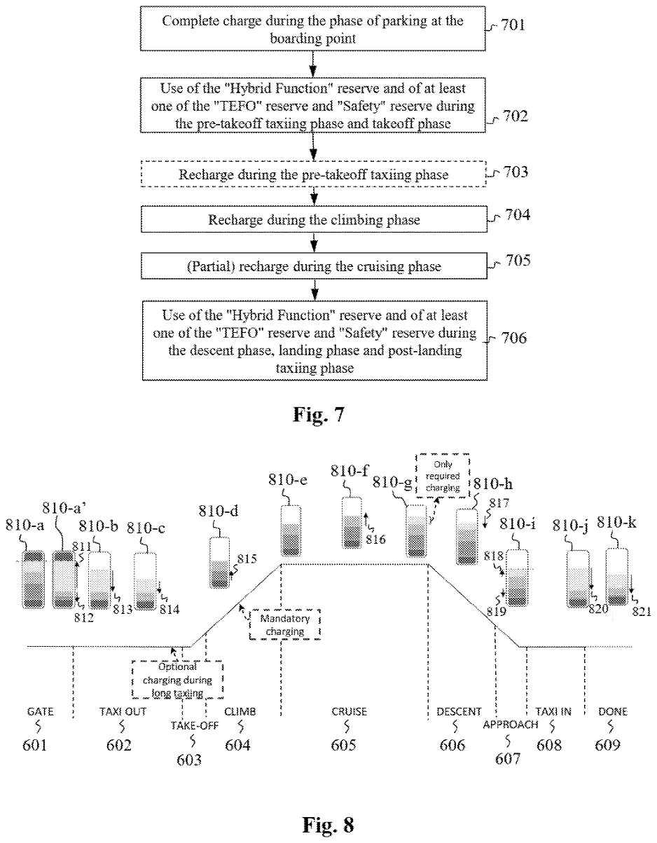

FIG. 7 schematically illustrates an energy management algorithm, executed by the system 40 for managing the battery 8, for a given mission of the aircraft 2, in a second embodiment comprising steps 701 to 706. It is described in conjunction with FIG. 8, which schematically illustrates the various states of charge of the battery 8 over the course of various phases of a given mission, when the algorithm of FIG. 7 is executed. In FIG. 8, the phases of the mission are identical to those depicted in FIG. 6 and referenced in the same way, 601 to 609.

The step 701 is identical to the step 501 of FIG. 5 (during the phase 601 of parking at the boarding point, the system 40 commands a complete charge of the battery 8). The state of charge of the battery 8 at the end of the step 701 is referenced 810-a in FIG. 8.

In the step 702, the system 40 authorizes use of the fourth reserve 404 (as in the step 502 of FIG. 5) and also of at least one of the second reserve and third reserve, 402 (“TEFO Reserve”) and 403 (“Safety Reserve”), to execute one or more of the hybrid functions, during the pre-takeoff taxiing phase 602 and/or during the takeoff phase 603. Thus, the amount of electrical energy which is available for executing hybrid functions during the ground operations (phases 602 and 603) is increased, taking advantage of the fact that, during the ground operations, the second reserve and third reserve 402, 403 are not required. FIG. 8 depicts two successive states, referenced 810-b and 810-c, of the state of charge of the battery 8 over the course of this step 702. The use of the fourth reserve 404 and of at least one of the second reserve and third reserve 402, 403, to execute one or more of the hybrid functions, is symbolized therein by the arrows referenced 813 and 814. Thus, and as illustrated by the (virtual and temporary) state of charge referenced 810-a′, authorizing the use of at least one of the second reserve and third reserve, 402 (“TEFO Reserve”) and 403 (“Safety Reserve”), in addition to the fourth reserve 404 (“Hybrid Function Reserve”) during the step 702, virtually (and temporarily) amounts to reducing the size of the second reserve 402 and/or the size of the third reserve 403, and increasing that of the fourth reserve 404 (as symbolized by the arrows referenced 812 and 811, respectively).

The step 703 is identical to the step 503 of FIG. 5. As a reminder, this is an optional step in which, if the pre-takeoff taxiing phase 602 is of a duration which is greater than a predetermined duration, the system 40 commands a recharge of the battery 8 during this phase 602, with a sufficient amount of energy for the fourth reserve 404 to be at least partially replenished and make it possible to execute one or more of the hybrid functions during the takeoff phase 603.

In the step 704 (which has no equivalent in the algorithm of FIG. 5), the system 40 commands a recharge of the battery during the climbing phase 604, with a sufficient amount of energy for the second reserve and third reserve 402, 403 to be fully replenished before the cruising phase 605. On the state of charge of the battery 8 referenced 810-d, this recharge is symbolized by the arrow referenced 815.

In one particular implementation of the step 704, during the climbing phase 604, the recharge of the battery 8 is configured to be gradual and such that each of the second reserve and third reserve 402, 403 is always replenished in a proportion which is at least equal to a first determined threshold (which may be different for each of the second reserve and third reserve), which is variable and rises as the altitude of the aircraft increases. Thus, the recharging of the battery 8 is further optimized. For example, for the third reserve 403 (which guarantees in-flight relighting of the engines 4, 6), the first threshold S1 is the equivalent of: one attempt (of a determined number of seconds) for an altitude which is less than or equal to a first value V1; two attempts for an altitude which is greater than the first value V1 and less than or equal to a second value V2, with V2>V1; and three attempts for an altitude which is greater than the second value V2 and less than or equal to a third value V3 (cruising altitude), with V3>V2. Likewise, for the second reserve 402 (which guarantees a continuous power supply to essential systems of the aircraft in the event of the engines 4, 6 flaming out), the first threshold S1′ is, for example, the equivalent of: a first duration D1 of continuous power supply to the essential systems of the aircraft for an altitude which is less than or equal to the first value V1; a second duration D2 (with D2>D1) of continuous power supply to the essential systems for an altitude which is greater than the first value V1 and less than or equal to the second value V2, with V2>V1; and a third duration D3 (with D3>D2) of continuous power supply to the essential systems for an altitude which is greater than the second value V2 and less than or equal to the third value V3 (cruising altitude), with V3>V2.

In the step 705, the system 40 commands a partial recharge of the battery during the cruising phase 605, with a limited amount of energy which is sufficient for the fourth reserve 404 to be partially replenished and make it possible, in combination (sum of reserves) with the second reserve 402 and/or the third reserve 403, to execute the step 706. In other words, the recharge of the battery 8 during the cruising phase 605 is limited and takes account of the authorization, in the following step 706, of use of at least one of the second reserve and third reserve 402, 403 to execute at least one of the hybrid functions during at least one of the descent phase 606, landing phase 607 and post-landing taxiing phase 608. The fact that the recharge of the battery 8 during the cruising phase 605 is limited makes it possible to reduce the recharge operations during the flight. In this case, a subsequent complete recharge on the ground, on arrival, is preferred. FIG. 8 depicts three successive states, referenced 810-e, 810-f and 810-g, of the state of charge of the battery 8 over the course of this step 705. The state 810-e is identical to the state 810-d (the battery 8 was partially recharged during the climbing phase 604). The recharge of the battery during the cruising phase 605 appears on the state 810-f, where it is symbolized by the arrow referenced 816. The state 810-g shows a partially charged battery (and not completely, as in the initial state 810-a) because, as explained above, the fourth reserve 404 and at least one of the second reserve and third reserve 402, 403 may be used during the step 706.

In the step 706, the system 40 authorizes use of the fourth reserve 404 and of at least one of the second reserve and third reserve 402, 403 to execute one or more of the hybrid functions, during the descent phase 606 and/or during the landing phase 607 and/or during the post-landing taxiing phase 608. Thus, the amount of electrical energy which is available for executing hybrid functions during the phases 606 and 608 is increased, taking advantage of the fact that, during these phases, the second reserve and third reserve 402, 403 are not required in full. FIG. 8 depicts two successive states, referenced 810-h and 810-j, of the state of charge of the battery 8 over the course of this step 706. The use of the fourth reserve 404 and of at least one of the second reserve and third reserve 402, 403, to execute one or more of the hybrid functions, is symbolized therein by the arrows referenced 817 and 820. Between these two states 810-h and 810-j, a (virtual) state of charge 810-i is depicted, illustrating the fact that authorizing the use of at least one of the second reserve and third reserve 402, 403, in addition to the fourth reserve 404 during the step 706, virtually (and temporarily) amounts to reducing the size of the second reserve 402 and/or of the third reserve 403 and increasing that of the fourth reserve 404 (as symbolized by the arrows referenced 819 and 818, respectively). In the example illustrated in FIG. 8, at the end of the post-landing taxiing phase 608 (and therefore at the beginning of the following phase 609 of parking at the boarding point), the state of charge of the battery 8 is referenced 810-k and shows that a portion of the sum of the second reserve, third reserve and fourth reserve 402, 403, 404 has been consumed (as symbolized by the arrow referenced 821).

In one particular implementation of the step 706, the authorization of use of at least one of the second reserve and third reserve 402, 403 is configured to be gradual and such that each of the second reserve and third reserve 402, 403 still contains energy in a proportion which is at least equal to a second determined threshold (which may be different for each of the second reserve and third reserve), which is variable and falls as the altitude of the aircraft decreases. Thus, the use of the battery 8 is further optimized. For example, for the third reserve 403, the second threshold is identical to the first threshold S1 defined above (for the particular implementation of the step 704); and, for the second reserve 402, the second threshold is, for example, identical to the first threshold S1′ (also defined above for the particular implementation of the step 704).

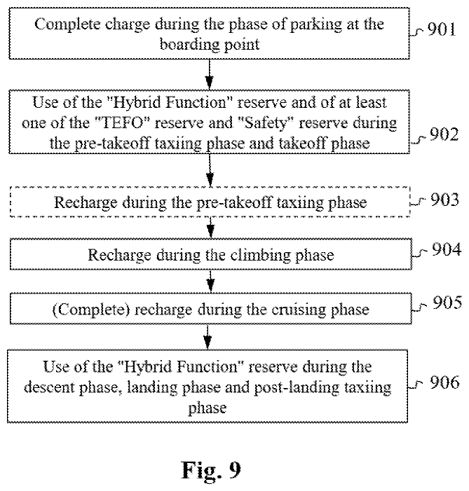

FIG. 9 schematically illustrates an energy management algorithm, executed by the system for managing the battery 8, in a third embodiment comprising steps 901 to 906.

The steps 901 to 904 are identical to the steps 701 to 704 of FIG. 5.

The step 905 differs from the step 705 of FIG. 5 in that the system 40 commands a complete (and not partial) recharge of the battery 8 during the cruising phase 605. Thus, at the end of this complete recharge, the fourth reserve 404 is fully replenished and authorizes, in the following step 906, the execution of all the hybrid functions which must be performed during the descent phase 606, landing phase 607 and post-landing taxiing phase 608. The fact that the recharge of the battery 8 during the cruising phase 605 is complete makes it possible to reduce the recharge operations on the ground, on arrival, and therefore also to reduce the turn around time of the aircraft (or TAT). The step 906 differs from the step 706 of FIG. 5 in that the system 40 authorizes use only of the fourth reserve 404 (and not of at least one of the second reserve and third reserve 402, 403) to execute one or more of the hybrid functions, during the descent phase 606 and/or during the landing phase 607 and/or during the post-landing taxiing phase 608. In fact, the use of at least one of the second reserve and third reserve 402, 403 is not necessary here since the battery 8 (and therefore the fourth reserve 404) has been fully recharged during the cruising phase 605.

1. A method for managing the energy of an electrical energy source in an aircraft comprising a system for managing the energy of said electrical energy source in an electric hybrid propulsion architecture comprising at least one heat engine using fuel combustion and said electrical energy source, the energy management system comprising electronic circuitry, the method being implemented by the energy management system and comprising, for a given mission of the aircraft:
during a phase of parking at the boarding point, commanding a complete charge of the electrical energy source with an amount of energy distributed, in a determined manner and for the whole duration of the given mission, between the following energy reserves:
a first reserve, which is a design safety margin designed to prevent the electrical energy source from exceeding its defined operational limits;
a second reserve, which guarantees a continuous power supply to essential systems of the aircraft in the event of said at least one engine flaming out;
a third reserve, which guarantees in-flight relighting of said at least one engine; and
a fourth reserve, provided for hybrid functions providing, through power injection, electrical assistance to said at least one engine in normal operation;
authorizing use of the fourth reserve to execute at least one of the hybrid functions, during at least one of the following phases: pre-takeoff taxiing and takeoff; and
commanding a recharge of the electrical energy source during a cruising phase, with a sufficient amount of energy for the fourth reserve (404) to be at least partially replenished and make it possible to execute at least one of the hybrid functions during at least one of the following phases: descent, landing and post-landing taxiing.

2. The method according to claim 1, comprising, for the given mission and if the pre-takeoff taxiing phase is of a duration which is greater than a predetermined duration:
commanding a recharge of the electrical energy source during the pre-takeoff taxiing phase, with a sufficient amount of energy for the fourth reserve to be at least partially replenished and make it possible to execute at least one of the hybrid functions during the takeoff phase.

3. The method according to claim 1, comprising:
authorizing use of at least one of the second reserve and third reserve to execute at least one of the hybrid functions, during at least one of the pre-takeoff taxiing phase and takeoff phase; and
commanding a recharge of the electrical energy source during a climbing phase, with a sufficient amount of energy for the second reserve and third reserve to be fully replenished before the cruising phase.

4. The method according to claim 3, wherein, during the climbing phase, the recharge of the electrical energy source is configured to be gradual and such that each of the second reserve and third reserve is always replenished in a proportion which is at least equal to a first determined threshold, which is variable and rises as the altitude of the aircraft increases.

5. The method according to claim 1, comprising:
authorizing use of at least one of the second reserve and third reserve to execute at least one of the hybrid functions, during at least one of the descent phase, landing phase and post-landing taxiing phase.

6. The method according to claim 5, wherein authorizing use of at least one of the second reserve and third reserve, to execute at least one of the hybrid functions during at least one of the descent phase, landing phase and post-landing taxiing phase, is configured to be gradual and such that each of the second reserve and third reserve still contains energy in a proportion which is at least equal to a second determined threshold, which is variable and falls as the altitude of the aircraft decreases.

7. The method according to claim 4, wherein the recharge of the electrical energy source during the cruising phase is limited and takes account of the authorization of use of at least one of the second reserve and third reserve to execute at least one of the hybrid functions during at least one of the descent phase, landing phase and post-landing taxiing phase.

8. The method according to claim 3, wherein the recharge of the electrical energy source during the cruising phase is complete, so that, at the end of said complete recharge, the fourth reserve is fully replenished and authorizes the execution of all the hybrid functions which must be executed during the descent phase, landing phase and post-landing taxiing phase.

9. (canceled)

10. A non-transitory storage medium, storing a computer program comprising instructions which cause a processor to execute the method according to claim 1, when said instructions are read from the storage medium and executed by the processor.

11. A system for managing the energy of an electrical energy source in an aircraft comprising an electric hybrid propulsion architecture comprising at least one heat engine using fuel combustion and said electrical energy source, the energy management system being on board the aircraft and comprising electronic circuitry configured to implement, for a given mission of the aircraft:
during a phase of parking at the boarding point, commanding a complete charge of the electrical energy source with an amount of energy distributed, in a determined manner and for the whole duration of the given mission, between the following energy reserves:
a first reserve, which is a design safety margin designed to prevent the electrical energy source from exceeding its defined operational limits;
a second reserve, which guarantees a continuous power supply to essential systems of the aircraft in the event of said at least one engine flaming out;
a third reserve, which guarantees in-flight relighting of said at least one engine; and
a fourth reserve, provided for hybrid functions providing, through power injection, electrical assistance to said at least one engine in normal operation;
authorizing use of the fourth reserve to execute at least one of the hybrid functions, during at least one of the following phases: pre-takeoff taxiing and takeoff; and
commanding a recharge of the electrical energy source during a cruising phase, with a sufficient amount of energy for the fourth reserve to be at least partially replenished and make it possible to execute at least one of the hybrid functions during at least one of the following phases: descent, landing and post-landing taxiing.

12. An aircraft comprising an energy management system according to claim 11.
